(19) United States
(12) Patent Application Publication
(10) Pub. No.: US 2013/0295972 A1
(43) Pub. Date: Nov. 7, 2013

(54) INTELLIGENT MOBILE-TERMINATED CALL PAGING CONTROL BEFORE AND DURING A LOCATION UP-DATE PROCEDURE

(71) Applicant: Juergen Grusdat, Bonn (DE)

(72) Inventor: Juergen Grusdat, Bonn (DE)

(73) Assignee: DEUTSCHE TELEKOM AG, Bonn (DE)

(21) Appl. No.: 13/822,716

(22) PCT Filed: Sep. 14, 2011
(86) PCT No.: PCT/EP11/04598

§ 371 Date: Mar. 13, 2013

Related U.S. Application Data
(60) Provisional application No. 61/382,556, filed on Sep. 14, 2010.

(30) Foreign Application Priority Data
Sep. 14, 2010 (EP) 10009528.0

(51) Int. Cl. H04W 68/04

(52) U.S. Cl. CPC H04W 68/04
USPC 455/458

(57) ABSTRACT

A method for paging a mobile device in a public land mobile network (PLMN) in view of a mobile-terminated communication event includes, upon the occurrence of the mobile-terminated communication event, broadcasting, by the PLMN, a first paging signal at a first paging time to locate the mobile device; and based on receiving no paging response from the mobile device in response to the first paging signal during a predefined time period, broadcasting, by the PLMN, a second paging signal at a second paging time. The time difference between the second paging time and the first paging time is based on whether a location update procedure is initiated during the predefined time period. The second paging time is delayed by a delay time if a location update procedure is initiated during the predefined time period.

### CROSS-REFERENCE TO RELATED APPLICATIONS

This application is a U.S. National Phase application under 35 U.S.C. §371 of International Application No. PCT/EP2011/004598, filed on Sep. 14, 2011, and claims benefit to U.S. Provisional Application No. 61/382,556, filed Sep. 14, 2010, and European Patent Application No. EP 10009528.0, filed on Sep. 14, 2010. The International Application was published in English on Mar. 22, 2012 as WO 2012/034681 A1 under PCT Article 21(2).

### FIELD

The invention relates to a method, a system, a program and a computer program product for paging a mobile device in a public land mobile network (PLMN) in view of a mobile-terminated communication event, wherein the mobile device is in the process of changing the location area of the PLMN and wherein a location update procedure is initiated.

### BACKGROUND

Today's public land mobile networks (PLMN) typically consist of a large number of cells each covering a certain geographic area, wherein each cell comprises one base station entity to communicate via radio interface with mobile devices located in said cell. Whenever a mobile-terminated communication event addressing a mobile device, e.g., a mobile-terminated call, is transmitted over the PLMN, the cell containing the mobile device has to be determined before a communication channel, e.g., a voice channel, between the PLMN and the mobile device can be established. For this purpose, the PLMN broadcasts a paging signal requesting a response of said mobile device.

Since broadcasting of paging signals in all cells of the entire PLMN would cause unadvantageously large traffic, so-called location areas have been introduced, which are typically composed of several cells of the PLMN and, thus, cover a larger geographic area. A mobile device transmits a location area identifier to the PLMN when changing the location area so that the PLMN is able to record the location of the mobile device by assigning the location area identifier to the mobile device in a location register. Thus, in case that the mobile device needs to paged, e.g., in view of a mobile-terminated communication event, it is possible to restrict the broadcasting of paging signals to a single location area so that broadcasting of the entire PLMN can be avoided and traffic can be advantageously reduced.

However, a drawback of using location areas is that each time a mobile device changes its location area, the mobile device will temporarily be not reachable by the PLMN (with respect to mobile terminating calls) due to a reorientation procedure which includes, e.g., scanning of signal strengths and frequencies of nearby base station entities as well as establishing a communication channel with one of the base transceivers stations of the new location area. This reorientation procedure may take a few seconds, or even up to 10 seconds. The duration of the reorientation procedure is particularly time consuming in case that the mobile device changes between location areas using different network technologies like, e. g., GSM and UMTS. Additionally, subsequent to the reorientation procedure, a location update procedure is initiated which typically takes a few seconds as well and includes, e. g., the processes of identification of the mobile device, authentication and ciphering. During the reorientation procedure and the location update procedure, the mobile device is not able to receive paging signals and, thus, paging upon a mobile-terminated communication event may fail. As a consequence, the mobile-terminated communication event may not be transmitted to the mobile device. This situation is unsatisfactory both for the network provider who gives away chargeable airtime and for the calling party, i.e., the addresser of the mobile-terminated communication event, who is not being connected to the called party.

### SUMMARY

The present invention provides a method for paging a mobile device in a public land mobile network (PLMN) in view of a mobile-terminated communication event, the mobile device being in the process of changing the location area of the PLMN, a location update procedure being initiated. The method includes the following steps: upon the occurrence of the mobile-terminated communication event, broadcasting, by the PLMN, a first paging signal at a first paging time to locate the mobile device; and based on receiving no paging response from the mobile device in response to the first paging signal during a predefined time period, broadcasting, by the PLMN, a second paging signal at a second paging time. The time difference between the second paging time and the first paging time is based on whether a location update procedure is initiated during the predefined time period. The second paging time is directly subsequent to the predefined time period if no location update procedure is initiated during the predefined time period. The second paging time is delayed by a delay time if a location update procedure is initiated during the predefined time period.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates a location update procedure in a PLMN.

FIG. 2 schematically illustrates a conventional method for paging a mobile device.

FIG. 3 schematically illustrates a method for paging a mobile device according to the present invention.

### DETAILED DESCRIPTION

Embodiments of the present invention provide an improved method, a system and a computer program product for paging a mobile device in a PLMN in view of a mobile-terminated communication event such that the above mentioned problems of the prior art are at least partly avoided.

In an embodiment, the present invention provides a method for paging a mobile device in a PLMN in view of a mobile-terminated communication event, wherein the mobile device is in the process of changing the location area of the PLMN and wherein a location update procedure is initiated, the method comprising the following steps:
upon the occurrence of the mobile-terminated communication event, the PLMN broadcasts a first paging signal at a first paging time to locate the mobile device
in case of receiving no paging response from the mobile device in response to the first paging signal during a predefined time period, the PLMN broadcasts a second paging signal at a second paging time, wherein the time difference between the second paging time and the first paging time depends on whether a location update procedure is initiated during the predefined time period, wherein in case that no location update procedure is initiated during the predefined time period, the second paging signal is broadcast at a time directly subsequent to the predefined time period, and wherein the broadcasting of the second paging signal is delayed by a delay time subsequent to the time of the initiation of the location update procedure.

In an embodiment, the present invention provides a method for paging a mobile device in a PLMN in view of a mobile-terminated communication event, wherein the mobile device is in the process of changing the location area of the PLMN and wherein a location update procedure is initiated, the method comprising the following steps:
upon the occurrence of the mobile-terminated communication event, the PLMN broadcasts a first paging signal at a first paging time to locate the mobile device
in case of receiving no paging response from the mobile device in response to the first paging signal during a predefined time period, the PLMN broadcasts a second paging signal at a second paging time, wherein the time difference between the second paging time and the first paging time depends on whether a location update procedure is initiated during the predefined time period.

According to the present invention, it is advantageously possible that the time for broadcasting the second paging signal is chosen depending on whether the mobile device is subjected to a location update procedure during the predefined time period and, thus, is not capable of receiving a paging signal for a certain time period. Preferably, in case that a location update procedure is detected during the predefined time period, the second paging time is chosen such that it is ensured that the mobile device has completed the location update procedure and is ready for receiving and responding to a paging signal when the second paging signal is broadcast. Thereby, it is advantageously possible to assure a successful paging procedure and to reduce the number of unsuccessful paging attempts upon a mobile-terminated communication event so that traffic load in the PLMN is minimized. Furthermore, it is advantageously possible according to the present invention that the time interval needed to establish a (mobile terminated) call can also be minimized Location update procedures primarily occur (or are initiated) in two situations: (1) in case of the mobile device changing the location area (i.e. moving from a first location area to a second location area), and (2) location area updates (or location area update procedures) in a stationary situation, i.e. location update procedures triggered by the PLMN without the mobile device changing the location area, the latter being also called “periodical location updates” that occur regularly according to a predetermined time interval. Both situations are addressed by the present invention as it is assured that,
the second paging signal is directed to the new location area (in case of the mobile device changing the location area), and
the second paging signal is sent at the earliest possible point in time such that such a second paging signal has reasonable chances of success (in both situations)

According to the present invention, a “mobile device” is any portable device that provides functionality to communicate with a PLMN via air interface, e. g., a mobile phone, a smart phone, a PDA or a laptop computer comprising a mobile radio network interface.

In the context of the present invention, a “mobile-terminated communication event” refers to any communication event that is transmitted over the PLMN and intended to terminate at the mobile device, wherein the communication event can be, e. g., a phone call, a short message, a multimedia message or any other mobile service provided by the PLMN.

According to the present invention, it is preferred that the location update procedure is initiated when a location update request sent by the mobile device is received at a network controller of the PLMN, wherein the network controller is preferably a Mobile Switching Center (MSC). Thus, in the context of the present invention, the time of the initiation of a location update procedure is determined by the time of receiving the location update request at the network controller. Usually, such a location update request is sent when the mobile device notices that the received location area code broadcast by a base station entity has changed. Although the present invention is described in the context of a location update procedure initiated in view of a change of the location area, one skilled in the art understands that the inventive method is also applicable in case of a location update procedure initiated when the mobile device is turned on or in case of a location update procedure initiated periodically. Within the context of the present invention, the base station entity means either:
a Base transceiver station for use within a Global System of Mobile Communication (GSM) mobile radio access network, or
the NodeB within an Universal Mobile Telecommunication System (UMTS) mobile radio access network, more precisely, the part of the NodeB entity handling the traffic of one radio cell.

According to the present invention, the PLMN comprises a radio access network (RAN), e. g., a GSM/EDGE radio access network (GERAN) and/or a UMTS radio access network (UTRAN), and a core network, e. g., a GSM core network and/or a GPRS core network. It is conceivable, that the PLMN is configured as a 2^{nd} generation network like, e.g., a conventional GSM network, as a 3^{rd} generation network like, e. g., an UMTS network, as any next generation network like, e. g., a 3.9G network or a 4G network, or as any combination of these network technologies.

According to the present invention, it is preferred that the mobile device is in the process of changing from a first location area comprising a first network technology to a second location area comprising a second network technology. The method according to the present invention is also applicable to the case of the same network technology (such as Global System of Mobile Communication (GSM) or Universal Mobile Telecommunication System (UMTS) technology) in both the first and second location area.

For instance, it is conceivable that the first location area is part of a GSM network and the second location area is part of an UMTS network or vice versa. In this case, the duration of the reorientation procedure of a mobile device in view of changing the location area is comparatively long so that the probability for an unsuccessful paging upon a mobile-terminated communication event using conventional paging techniques known in the prior art is relatively high. However, the paging success rate is significantly improved by using the method according to the present invention.

According to the present invention, it is preferred that the mobile device is in the process of changing from a first location area served by a network controller to a second location area served by the same network controller, wherein the network controller is preferably a MSC.

According to the present invention, it is preferred that the mobile device is in the process of changing from a first location area to a second location area, wherein in case that a location update procedure is initiated during the predefined time period, the second paging signal is broadcast to the second location area.

Thereby, it is advantageously ensured that the mobile device is capable of receiving and responding to the second paging signal after completion of the location update procedure.

According to the present invention, it is preferred that in case that no location update procedure is initiated during the predefined time period, the second paging signal is broadcast directly subsequent to the predefined time period.

Thereby, it is advantageously possible that in case that the mobile device is not subjected to a location update procedure, the second paging signal is promptly broadcast subsequent to the predefined time period without any additional time delay so that the duration of the paging procedure can be kept comparatively short.

According to the present invention, it is preferred that in case that a location update procedure is initiated during the predefined time period, the second paging signal is broadcast at a time after the location update procedure has completed.

Thereby, it is advantageously possible to assure that the mobile device is ready to receive and respond to paging signals at the time when the second paging signal is broadcast so that the number of unsuccessful paging signals is reduced and traffic load and costs can be minimized. Furthermore, it is advantageously possible according to the present invention that the time interval needed to establish a (mobile terminated) call can also be minimized

According to the present invention, it is preferred that the broadcasting of the second paging signal is delayed by a delay time subsequent to the time of the initiation of the location update procedure.

In this context, “delayed” means that the second paging signal is broadcast not before the time period defined by the delay time has elapsed. The delay time is preferably chosen in such a way that it is ensured that the location update procedure has been completed when the time period defined by the delay time has elapsed and the second paging signal is broadcast. For this purpose, it is conceivable, to choose the delay time larger than the typical duration of a location update procedure. Thereby, it is advantageously guaranteed that the mobile device is ready to receive and respond to the second paging signal when said second paging signal is broadcast. On the other hand, it is preferred to choose a comparatively small delay time to keep the duration of the paging procedure advantageously short and, hence, to provide a fast communication establishment upon a mobile-terminated communication event. Preferably, both requirements are fulfilled if the delay time is chosen between 2.0 seconds and 6.0 seconds, more preferably between 2.5 seconds and 5.5 seconds and even more preferably between 3.5 seconds and 4.5 seconds. Furthermore, it is preferred that the delay time is a fixed value, wherein “fixed” means that the same delay time is chosen for each paging procedures being performed. Thereby, it is advantageously possible to implement the inventive method in the PLMN without major efforts.

According to an alternative embodiment of the present invention, it is preferred that in case that a location update procedure is initiated during the predefined time period, the broadcasting of the second paging signal is triggered by the completion of the location update procedure.

Thereby, it is advantageously possible that the second paging signal is broadcast directly subsequent to the time of completion of the location update procedure. It is conceivable, that the broadcasting of the second paging signal is triggered by the transmission of a location update acknowledgment message from the PLMN to the mobile device which indicates that the location update procedure has been successfully completed. Thereby, it is advantageously possible to both assure that the mobile device is ready to receive and respond to the second paging signal when said second paging signal is broadcast and that the time difference between the first paging signal and the second paging signal is kept as short as possible.

The present invention further relates to a system for paging a mobile device in a PLMN in view of a mobile-terminated communication event, wherein the mobile device is in the process of changing the location area of the PLMN and wherein a location update procedure is initiated, wherein the PLMN comprises a network controller providing means for executing a location update procedure and initiating the broadcasting of a paging signal to locate the mobile device, wherein, upon the occurrence of a mobile-terminated communication event, the network controller broadcasts a first paging signal at a first paging time to locate the mobile device, wherein, in case of receiving no paging response from the mobile device in response to the first paging signal during a predefined time period, the network controller broadcasts a second paging signal at a second paging time, wherein the time difference between the second paging time and the first paging time depends on whether a location update procedure is initiated during the predefined time period, wherein in case that no location update procedure is initiated during the predefined time period, the second paging signal is broadcast at a time directly subsequent to the predefined time period, and wherein the broadcasting of the second paging signal is delayed by a delay time subsequent to the time of the initiation of the location update procedure.

The present invention furthermore also relates to a system for paging a mobile device in a PLMN in view of a mobile-terminated communication event, wherein the mobile device is in the process of changing the location area of the PLMN and wherein a location update procedure is initiated, wherein the PLMN comprises a network controller providing means for executing a location update procedure and initiating the broadcasting of a paging signal to locate the mobile device, wherein, upon the occurrence of a mobile-terminated communication event, the network controller broadcasts a first paging signal at a first paging time to locate the mobile device, wherein, in case of receiving no paging response from the mobile device in response to the first paging signal during a predefined time period, the network controller broadcasts a second paging signal at a second paging time, wherein the time difference between the second paging time and the first paging time depends on whether a location update procedure is initiated during the predefined time period.

Thereby, it can be advantageously ensured that a mobile device which is in the process of changing its location area is successfully paged upon a mobile-terminated communication event.

The present invention further relates to a program comprising a computer readable code that when executed performs a method for paging a mobile device in a PLMN in view of a mobile-terminated communication event according to present invention.

The present invention further relates to a computer program product comprising a computer-readable storage medium having computer-readable instructions embodied in the medium for executing a method for paging a mobile device in a PLMN in view of a mobile-terminated communication event according to present invention.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

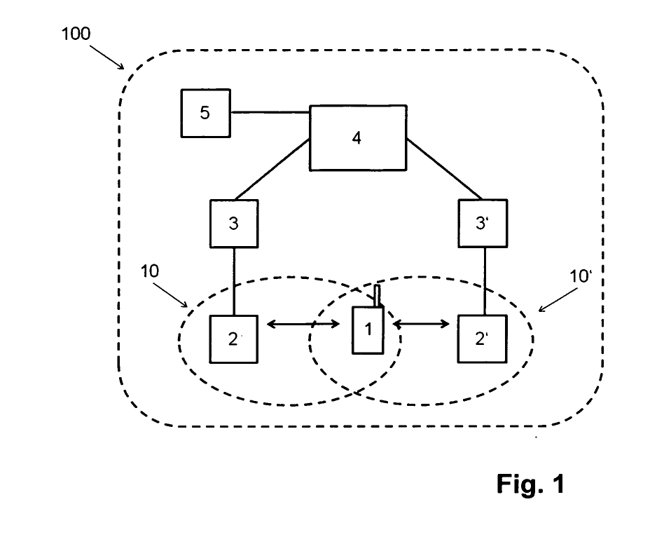

Referring to FIG. 1, a public land mobile network (PLMN) 100 is illustrated, wherein the PLMN 100 is divided into a plurality of location areas 10, 10′ which cover a certain geographic area of the entire PLMN 100. It is to mention that each location area 10, 10′ is, furthermore, composed of one or several cells (not illustrated). Each location area 10, 10′ comprises one or more base station entities 2, 2′ which provide means to transmit signals to and receive signals from a mobile device 1 located in the corresponding location area 10, 10′ via air interface, wherein the mobile device 1 can be any portable device capable of communicating with the PLMN 100 via air interface like, e. g., a mobile phone, a smart phone, a PDA or a laptop computer. The base station entities 2, 2′ are connected, e.g. via base station controllers 3, 3′ (for the case of a Global System of Mobile Communication (GSM) network) or via a Radio Network Controller (for the case of an Universal Mobile Telecommunication System (UMTS) network), to a network controller 4, e. g., a Mobile Switching Center (MSC). The network controller 4 is responsible for routing mobile-terminated and mobile-originated communication events, e.g., phone calls, short messages or other mobile services. Furthermore, the network controller 4 provides functionality for recording the location area information of a mobile device 1 within the PLMN 100. For this purpose, the network controller 4 is arranged to store and maintain the location area information of the mobile device 1 in a location register 5, e. g., a visitor location register (VLR) or a home location register (HLR). It is conceivable that the location register 5 is either embedded in the network controller 4 or is a separate entity of the PLMN 100.

Whenever the mobile device 1 moves from a first location area 10 to a second location area 10′, the mobile device 1 sends a location update request for the initiation of a location update procedure to the PLMN 100 so that the location area information stored in the location register 5 is being updated by the network controller 4. It is to mention that a location update request can also be sent by the mobile device 1 periodically or upon turning on the mobile device 1. Furthermore, it is to mention that the first and the second location area 10, 10′ can comprise the same network technology, e. g., a GSM network technology, or can comprise different network technologies, e. g., a GSM network technology and an UMTS network technology.

Based on the location area information stored in the location register 5, the network controller 4 is able to page the mobile device 1 upon a mobile-terminated communication event addressing said mobile device 1. The paging procedure includes that the network controller 4 initiates the broadcasting of a paging signal via the base station entity 2, 2′ serving the current location area 10, 10′ of the mobile device 1. If the mobile device 1 receives the paging signal, it will send a paging response to the network controller 4 so that a connection between the mobile device 1 and the PLMN 100 can be established and the mobile-terminated communication event can be delivered to the mobile device 1.

However, the paging procedure may fail if the mobile device 1 is in a state of not being capable of receiving and responding to paging signals. In particular, such situation may occur if the mobile device 1 is currently in the process of changing from the first location area 10 to the second location area 10′. In this case, the mobile device 1 is not reachable by the PLMN 100 (with respect to mobile terminating calls) due to a reorientation procedure, which includes scanning of signal strengths and frequencies of all base station entities 2, 2′ within reach of the mobile device 1 as well as establishing a communication channel with the base station entity 2′ serving the new location area 10′. Furthermore, subsequent to the reorientation procedure the above mentioned location update procedure is carried out during which the mobile device 1 is unable to receive and respond to paging signals as well.

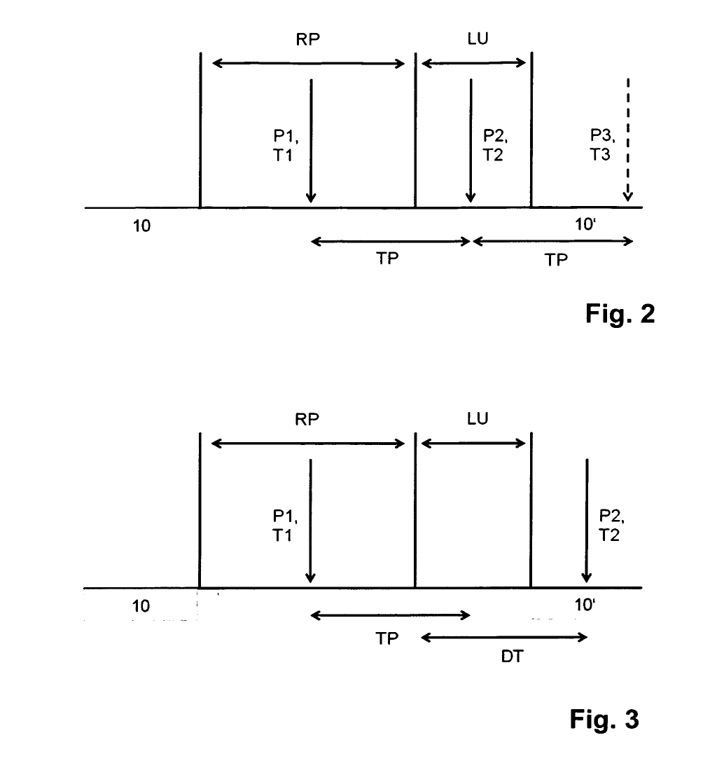

FIG. 2 schematically shows a “conventional” procedure for paging a mobile device 1 while the mobile device 1 is in the process of changing from a first location area 10 to a second location area 10′. In case that a mobile-terminated communication event addressing the mobile device 1 occurs which needs to be routed by the network controller 4 of the PLMN 100 to the mobile device 1, the network controller 4 determines the location area 10 of the mobile device 1 which is recorded in the location register 5 of the PLMN 100 and then broadcasts a first paging signal P1 at a first paging time T1 to said determined location area 10 in order to locate and to establish a connection with the mobile device 1. Along with the broadcasting of the first paging signal Pl, the network controller 4 starts a first timer having the duration of a predefined time period TP which determines how long one will wait for a page response from the mobile device 1 before a second paging signal P2 is broadcast. Typically, the predefined time period TP has a duration of a few seconds, preferably about 4 seconds. As illustrated, the mobile device 1 is subjected to a reorientation procedure RP when the first paging signal P1 is broadcast and, thus, not capable of receiving and responding to said first paging signal P 1. Therefore, no page response is received by the network controller 4 before the first timer expires and, according to the conventional paging procedure, a second paging signal P2 is broadcast by the network controller 4 at a second paging time T2 directly subsequent to the time period TP. Along with the broadcasting of the second paging signal P2, a second timer having again the duration of the predefined time period TP is started and the network controller 4 again asks whether a page response from the mobile device 1 is transmitted during said predefined time period TP. However, as illustrated, at the second paging time T2 the mobile device 1 is subjected to a location update procedure LU. Thus, the mobile device 1 is still not capable of receiving and responding to paging signals and no page response in response to the second paging signal P2 from the mobile device 1 is received by the network controller 4 before the second timer expires. Eventually, the conventional paging procedure will be stopped at this point and the mobile-terminated communication event will not be delivered to the mobile device 1. Alternatively, the network controller 4 broadcasts a third paging signal P3 at a third paging time T3 when the second timer expires. Even if at the third paging time T3, the location update procedure LU is completed (so that the mobile device 1 could then able to respond to said third paging signal P3 and a connection between the PLMN 100 and the mobile device 1 could be established), the conventional procedure requires the third paging signal to be sent to the first location area and consequently (as the

Substitute Specification (Clean Version) mobile device is in the second location area) no connection can be established. Even if such a third paging signal would be sent to the second location area (which it is not conventionally), this third paging signal P3 would cause additional traffic and is, therefore, unadvantageously cost-intensive.

The drawbacks of the above mentioned conventional paging procedure are overcome by the method according to the present invention as schematically illustrated in FIG. 3. Similar to the conventional paging procedure described for FIG. 2, the paging procedure according to the present invention is initiated by a mobile-terminated communication event addressing the mobile device 1 while the mobile device 1 is in the process of changing from a first location area 10 to a second location area 10′, wherein the paging procedure begins with the broadcasting of a first paging signal P1 at a first paging time Ti by the network controller 4. Moreover, similar to the conventional paging procedure, along with the broadcasting of the first paging signal P1 the network controller 4 starts a timer having the duration of a predefined time period TP which determines how long one will wait for a page response from the mobile device 1 before a second paging signal P2 is broadcast. In contrast to the conventional paging procedure, however, the network controller 4 also detects whether a location update procedure LU for the mobile device 1 is initiated during the predefined time period TP. In case that the initiation of a location update procedure LU is detected by the network controller 4, e. g., by receiving a location update request from the mobile device 1, and in case that no page response from the mobile device 1 has been received by the network controller 4 so far, the broadcasting of the second paging signal P2 will be delayed until the location update procedure LU is completed. According to the illustrated embodiment, such a delay is realized by extending the duration of the timer by a predefined delay time DT as soon as the initiation of the location update procedure LU is detected. The delay time DT is preferably chosen larger than the typical duration of a location update procedure LU, preferably about 4 seconds. Thereby, it can be advantageously assured that the location update procedure LU has been completed and the location area information of the mobile device 1 stored in the location register 5 of the PLMN 100 has been updated when the extended timer expires. The mobile device 1 is, thus, ready to receive and respond to the second paging signal P2 which is broadcast upon the expiration of the extended timer. Thereby, the method according to the present invention advantageously guarantees that a maximum of only two paging signals needs to be broadcast to successfully page the mobile device 1 while the mobile device 1 is in the process of changing its location area 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

1-10. (canceled)

11. A method for paging a mobile device in a public land mobile network (PLMN) in view of a mobile-terminated communication event, wherein the mobile device is in the process of changing the location area of the PLAIN and wherein a location update procedure is initiated, the method comprising the following steps:
upon the occurrence of the mobile-terminated communication event, broadcasting, by the PLMN, a first paging signal at a first paging time to locate the mobile device; and
based on receiving no paging response from the mobile device in response to the first paging signal during a predefined time period, broadcasting, by the PLMN, a second paging signal at a second paging time, wherein the time difference between the second paging time and the first paging time is based on whether a location update procedure is initiated during the predefined time period;
wherein the second paging time is directly subsequent to the predefined time period if no location update procedure is initiated during the predefined time period, and wherein the second paging time is delayed by a delay time if a location update procedure is initiated during the predefined time period.

12. The method according to claim 11, wherein the mobile device is in the process of changing from a first location area comprising a first network technology to a second location area comprising a second network technology.

13. The method according to claim 11, wherein the mobile device is in the process of changing from a first location area served by a network controller to a second location area served by the same network controller.

14. The method according to claim 13, wherein the network controller is a Mobile Switching Center (MSC).

15. The method according to claim 11, wherein the mobile device is in the process of changing from a first location area to a second location area, wherein in case that a location update procedure is initiated during the predefined time period, the second paging signal is broadcast to the second location area.

16. The method according to claim 11, wherein in case that a location update procedure is initiated during the predefined time period, the second paging time is at a time after the location update procedure has been completed,

17. The method according to claim 11, wherein the delay time is a fixed value.

18. The method according to claim 17, wherein the delay time is between 2.0 seconds and 6.0 seconds.

19. The method according to claim 17, wherein the delay time is between 2.5 seconds and 5.5 seconds.

20. The method according to claim 17, wherein the delay time is between 35 seconds and 4.5 seconds.

21. The method according to claim 11, wherein in case that a location update procedure is initiated during the predefined time period, the broadcasting of the second paging signal is triggered by the completion of location update procedure.

22. A system for paging a mobile device in a public land mobile network (PLMN) in view of a mobile-terminated communication event where the mobile device is in the process of changing the location area of the PLMN and wherein a location update procedure is initiated, the system comprising:
a network controller, configured to execute a location update procedure and to initiate the broadcasting of a paging signal to locate the mobile device;
wherein, the network controller is configured to initiate, upon the occurrence of a mobile-terminated communication event, the broadcasting of a first paging signal at a first paging time to locate the mobile device;
wherein the network controller is configured to broadcast, in case of receiving no paging response from the mobile device in response to the first paging signal during a predefined time period, a second paging signal at a second paging time wherein the time difference between the second paging time and the first paging time depends on whether a location update procedure is initiated during the predefined time period.

23. A non-transitory computer-readable medium having computer-executable instructions stored thereon for paging a mobile device in a public land mobile network (PLMN) in view of a mobile-terminated communication event, wherein the mobile device is in the process of changing the location area of the PLM N and wherein a location update procedure is initiated, the computer-executable instructions, when executed by a processor, causing the following steps to be performed:
upon the occurrence of the mobile-terminated communication event, broadcasting a first paging signal at a first paging time to locate the mobile device; and
based on receiving no paging response from the mobile device in response to the first paging signal during a predefined time period, broadcasting a second paging signal at a second paging time, wherein the time difference between the second paging time and the first paging time is based on whether a location update procedure is initiated during the predefined time period;
wherein the second paging time is directly subsequent to the predefined time period if no location update procedure is initiated during the predefined time period, and wherein the second paging time is delayed by a delay time if a location update procedure is initiated during the predefined time period.
